(19) United States
(12) Patent Application Publication
(10) Pub. No.: US 2017/0203267 A1
(43) Pub. Date: Jul. 20, 2017

(54) Apparatuses and Methods for Formulating Using a Swirl Chamber

(71) Applicant: Dr. Py Institute LLC, New Milford, CT (US)

(72) Inventors: Daniel Py, Larchmont, NY (US); Debashis Sahoo, Danbury, CT (US)

(21) Appl. No.: 15/410,513

(22) Filed: Jan. 19, 2017

Related U.S. Application Data
(60) Provisional application No. 62/280,691, filed on Jan. 19, 2016.

(51) Int. Cl. B01F 5/00; B01F 3/08; B01F 3/20; B01F 15/02

(52) U.S. Cl. CPC B01F 5/0062; B01F 15/0245; B01F 3/0861; B01F 3/20; B01F 2215/0014; B01F 2215/0031; B01F 2215/0032; B01F 2215/0022

(57) ABSTRACT

An outer shell and nozzle portion define therebetween a swirl chamber having a plurality of inlet flow paths and an outlet flow path. The swirl chamber may receive a plurality of substances or components from separate sources, to mix the plurality of substances in the swirl chamber, and to deliver the mixed substances or formulation through an outlet, e.g., to a connector. The substances may be sterile, and the entire flow path from the substance sources to the container may be sterile and aseptically sealed from ambient atmosphere. The outer shell and nozzle portion may be constructed of plastic or other disposable materials. The swirl chamber may be constructed to optimize the mixing of the substances through control of the velocity by which each substance enters the swirl chamber.

### CROSS-REFERENCE TO RELATED PATENT APPLICATIONS

This patent application claims benefit under 35 U.S.C. §119 to U.S. provisional patent application Ser. No. 62/280,691, filed 19 Jan. 2016, entitled “Apparatuses and Methods for Formulating Using a Swirl Chamber,” which is hereby incorporated by reference in its entirety as part of the present disclosure.

### FIELD OF THE INVENTION

The present invention relates to apparatuses and methods for formulating products, and more particularly, to apparatuses and methods for aseptically formulating and/or mixing products using a swirling or mixing chamber.

### BACKGROUND INFORMATION

Many products are composed of different ingredients, components or substances. To make the end product, the components are combined and mixed together. Many different mixing apparatuses and methods are known. One such device is the Ready-Mix by Pall Corporation. In magnetic mixing, a magnetically-driven mechanical mixing device, such as a magnetic impeller or stirrer, is placed into a mixing container and then suspended and propelled, e.g., rotated or oscillated, using a magnetic drive located outside the mixing container. Such apparatuses allow mixing at room temperature, and permit mixing of components within a closed container without any of the mixing components, e.g., a drive shaft, extending through the wall and into the container. This helps prevent exposure of the mixed product to the ambient atmosphere, which may be desirable or necessary, to avoid contact of the product with air or environmental organisms, avoid loss of product to the environment, or avoid release of harmful or undesirable substances from the container into the environment.

However, the mixing process can be time consuming, especially when one or more of the liquid components are to be mixed with low concentration. It can take a long time, e.g., several hours, to prepare a homogeneous solution of liquid components, with one or more liquid components having a low concentration. Further, even with extended mixing time, it is possible that the resulting product will not be sufficiently homogenous, such that, in a local area within the mixing container, the ingredients are not fully mixed or homogenous, or do not reach the proportions, concentrations, or amount desired or specified for the final formulated product.

This can result in product inconsistency, leading to quality control issues or customer dissatisfaction. Moreover, for some products, variation from specification can be deleterious to product functionality. For example, many products, such as drugs and medicaments, must be at or near specification in order to be safe and effective. Variation from specification can violate applicable regulations and laws.

In addition, sterility and shelf life are important considerations in the manufacture of many products, such as medicaments, liquid nutrition products, beverages, and creams. Manufacturing practices often must achieve final products with assured microbial safety, e.g., sterility. Traditionally, this means products must be sterilized by heat processing or radiation to reduce any potential microbial contamination to meet or exceed the levels of sterility prescribed for such products in national and international legislation. In addition, formulated (mixed) products may not be stable over time. Where products must be or are stored for extended periods of time, unstable components cannot be included without deterioration or must be over-dosed to ensure that minimal quantities remain at point of consumption. For many products, such as medicaments, the composition of the produced product must strictly adhere to specifications, including the amount and proportion of the ingredients or components of the product. Other products, such as infant formulas and other liquid nutrition products, it is desirable that the products contain certain essential nutrients, such as all of the essential nutrients needed for human infant growth and development in the case of infant formula.

Traditional processing methods require heat processing or irradiating a product after it has been mixed to final form. Products in liquid form, for example, are typically subject to a rigorous heat treatment typically by exposure to high temperatures for short time (Ultra-High Temperature processing (UHT)) or by retorting. While these thermal treatments can be successful in assuring microbial safety, they can adversely affect the molecular components and structures that are ingredients in these liquid products, such as infant formulas and other liquid nutrition products. Invariably, heat-treating complex mixtures leads to various reactions of individual molecules and to interactions between different components. UHT is a means to limit the high temperature exposure of the final formulation for too long. However, UHT typically requires a compromise with respect to sterilization levels.

Radiation, e.g., by beta gamma, e-beam, ultraviolet radiation, etc., typically can achieve high levels of sterility. On the other hand, irradiation can also have adverse effects on certain molecules. Radiation can, for certain materials, damage or discolor, or change the molecular structure of a material, sometimes with adverse affects on persons or other living things. In the case of an ingestible product, irradiation can undesirably affect the taste or texture of a material. This can deter a person or animal from ingesting the product, which, in the case of a nutrition product or medicament, may lead to the user not receiving the full benefit of the product.

In view of the above, it may be desirable to separately sterilize different components of a product using different methods, each selected to adequately sterilize or sanitize the component without adverse effects. U.S. Pat. No. 8,646,243, which is incorporated by reference herein, discloses apparatuses and methods for formulating and aseptically filling liquid products containing two or more components. Each ingredient can be sterilized separately according to the best method for that ingredient. For example, powders can be irradiated, solutions can be micro-filtered, water or mineral substances can be UHT sterilized, and oily substances can be beta irradiated or UHT sterilized. After this separate sterilization, each liquid component is sterile filled, through a separate filling member, into a single container, where the ingredients are mixed.

### SUMMARY OF THE INVENTION

It is an object of the present invention to overcome one or more of the above-described drawbacks and/or disadvantages.

The present disclosure relates to, inter alia, apparatuses and method for using a swirl chamber to facilitate intact mixing of ingredients.

In some aspects, the apparatus includes a body including a swirl chamber therein, at least two inlet flow paths in fluid communication with the swirl chamber for delivering substance into the swirl chamber, and an outlet aperture in fluid communication with the swirl chamber for substance to pass out of the swirl chamber, wherein one or more of the inlet flow paths is in fluid communication with a first substance and one or more of inlet flow paths is in fluid communication with a second substance that is different than the first substance so that the first substance and the second substance entering the swirl chamber are mixed in the swirl chamber, and the resulting mixture exits the swirl chamber through the outlet aperture. In some embodiments, the body includes a nozzle portion defining said outlet aperture, and an outer shell positioned over and engaged with the nozzle portion, such that the nozzle portion and the outer shell define therebetween the swirl chamber and at least part of the inlet flow paths. In some such embodiments, the inlet flow paths are defined at least in part by a recess in the outer shell. In some embodiments at least a portion of one or more of the inlet flow paths are tapered. An inlet flow path may be shaped or configured to define or provide an increase of flow exit velocity and, accordingly, velocity entering the swirl chamber (as compared to velocity at the entrance of the inlet flow path). In some such embodiments, the shape or configuration increases the velocity with a minimized head or energy loss for the increase achieved.

Some embodiments include more than two inlet flow paths. In some such embodiments, each inlet flow path delivers a different ingredient into the swirl chamber. In other such embodiments, more than one inlet flow path carries the same ingredient into the swirl chamber. In some embodiments, the swirl chamber defines a substantially annular or a substantially cylindrical shape. In some embodiments, the inlet flow paths intersect or expel flow into the swirl chamber at least substantially tangentially, e.g., at a tangential angle, to the swirl chamber.

In further embodiments, a pump pumps the substances to their respect flow inlet paths. In some such embodiments, the pump does not contact the substance, e.g., a peristaltic pump. In some embodiments, separate pumps pump different substances.

In some embodiments, outlet conduit or tube is sealingly engaged with the outlet aperture, each inlet flow path has an inlet conduit or tube sealing engaged therewith. The ends of the conduits (i.e., the upstream end of the inlet conduits and the downstream end of the outlet conduit) each include a sterile connector portion sealingly engaged therewith. Accordingly, in some such embodiments, all surfaces over which substance flows between said upstream end(s) and said downstream end, including into, through, and out of the body, are sterile and hermetically sealed from ambient atmosphere. The sterile connector portions maintain said surfaces hermetically sealed from ambient atmosphere at all times, even during disconnection and reconnection of the sterile connector portions (e.g., to another sterile connection portion).

In some embodiments, an apparatus includes a swirl chamber having a plurality of inlet flow paths and an outlet flow path; a plurality of substance sources, each source in communication with a respective inlet flow path, and comprising a reservoir, an inlet tube, and a peristaltic pump for pumping substance from the inlet tube into the inlet flow path; an outlet tube in fluid communication with the outlet flow path; and a connector in fluid communication with the outlet flow path and configured to deliver the mixed sterile formulation or product from the outlet tube to another container, e.g., a sterile, closed container.

In another aspect, a method includes:
flowing a first substance through a first inlet flow path and into a swirl chamber;
flowing a second substance that is different from the first substance through a second inlet flow path and into the swirl chamber;
mixing the first substance and the second substance within the swirl chamber; and
dispensing a resultant mixed product out of the swirl chamber.

Some embodiments include pumping the first substance from a source thereof to the first inlet flow path and the second substance from a source thereof to the second inlet flow path, where in some such embodiments the pumping is performed by pump(s) that do not contact the first substance or the second substance. Some embodiments include flowing one or more additional substances though one or more additional inlet flow paths and into the swirl chamber, and mixing said in the swirl chamber with the first and second substances. Some embodiments include flowing the first (or second) substance through one or more additional inlet flow paths. That is, a substance can be fed to the swirl chamber via multiple inlet flow paths. In some embodiments, the substances are flowed into the swirl chamber at a substantially tangential direction or angle thereto. In some embodiments, the substances are flowed within the swirl chamber in a substantially circumferential direction and/or an upward spiral direction.

Some embodiments include increasing the flow velocity of the first and/or second substances within its respective inlet flow path(s) (e.g., as compared to the velocity at which it enters the inlet flow path(s). In some such embodiments, head or energy loss is minimized during the increase in velocity.

In some embodiments, mixed product is dispensed, e.g., through the outlet of the swirl chamber, to a filling machine and/or a sterile, closed container. In some embodiments, the method includes aseptically connecting an inlet flow path to a source of the respective substance for that inlet flow path. Some embodiments include sterilizing the different substances (e.g., the first and second substance) with different sterilizing procedures.

In other embodiments, a method includes pumping a plurality of ingredients into a swirl chamber; mixing the ingredients within the swirl chamber; and delivering the mixed formulation or product through an outlet path of the swirl chamber, through a connector, and into a container, e.g., a sterile, closed container.

Other objects and/or advantages of the present invention, and/or of embodiments thereof, will become readily apparent in view of the following detailed description of embodiments and the accompanying drawings.

However, while various objects, features and/or advantages have been described in this Summary and/or will become more readily apparent in view of the following detailed description and accompanying drawings, it should be understood that such objects, features and/or advantages are not required in all aspects and embodiments.

This Summary is not exhaustive of the scope of the present aspects and embodiments. Thus, while certain aspects and embodiments have been presented and/or outlined in this Summary, it should be understood that the present aspects and embodiments are not limited to the aspects and embodiments in this Summary. Indeed, other aspects and embodiments, which may be similar to and/or different from, the aspects and embodiments presented in this Summary, will be apparent from the description, illustrations and/or claims, which follow.

It should also be understood that any aspects and embodiments that are described in this Summary and do not appear in the claims that follow are preserved for later presentation in this application or in one or more continuation patent applications.

It should also be understood that any aspects and embodiments that are not described in this Summary and do not appear in the claims that follow are also preserved for later presentation or in one or more continuation patent applications.

### BRIEF DESCRIPTION OF THE DRAWINGS

FIG. 1 is top perspective view of an outer shell and a nozzle portion assembly that forms a swirl chamber;

FIG. 2 is a front perspective view of the assembly of FIG. 1;

FIG. 3 is a cross-sectional perspective view of the assembly of FIG. 1;

FIG. 4 is a cross-sectional view of the nozzle portion of FIG. 1;

FIG. 5 is a top perspective view of the cross section of the nozzle portion of FIG. 1;

FIG. 6 is a top perspective view of the nozzle portion of FIG. 1;

FIG. 7 is a top view of the nozzle portion of FIG. 1;

FIG. 8 is a front perspective view of the nozzle portion of FIG. 1;

FIG. 9 is a bottom perspective view of the outer shell of FIG. 1;

FIG. 10 is a bottom view of the outer shell of FIG. 1;

FIG. 11 is a left bottom perspective view of the outer portion of FIG. 1;

FIG. 12 is a top perspective view of the outer portion of FIG. 1;

FIG. 13 is an exploded front perspective view of the assembly of FIG. 1;

FIG. 14 is an exploded bottom perspective view of the assembly of FIG. 1, illustrating three inlet ports located in the nozzle portion that are isolated from each other;

FIG. 15 is a cross-sectional view of the assembly of FIG. 1, illustrating a flow path into and through a swirl chamber formed by the assembly of FIG. 1;

FIG. 16 is a top perspective view of the cross sectional view of assembly of FIG. 15, illustrating said flow path; and

FIG. 17 is a schematic diagram illustrating the layout of a formulation and filling environment.

### DETAILED DESCRIPTION OF EMBODIMENTS

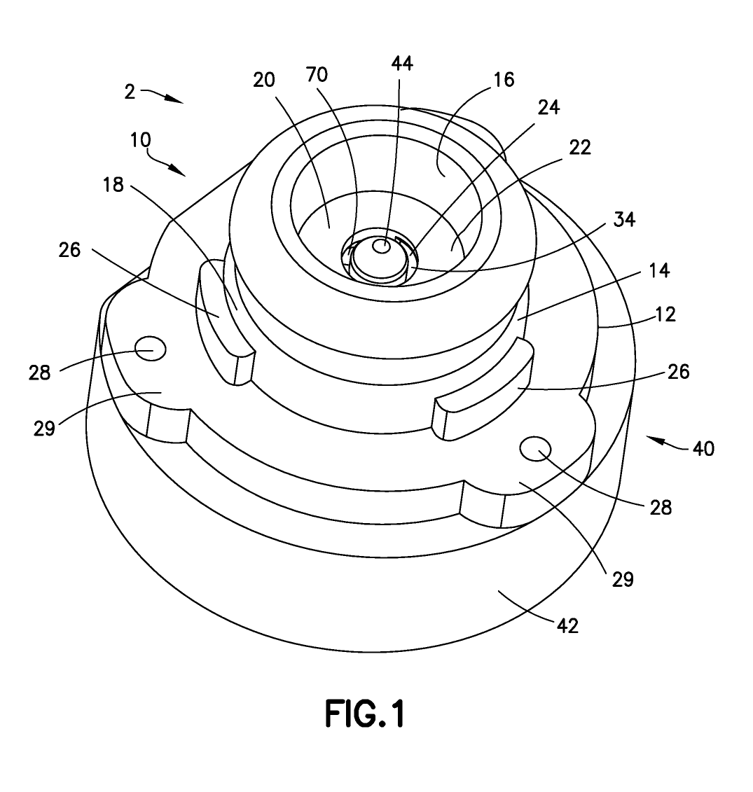

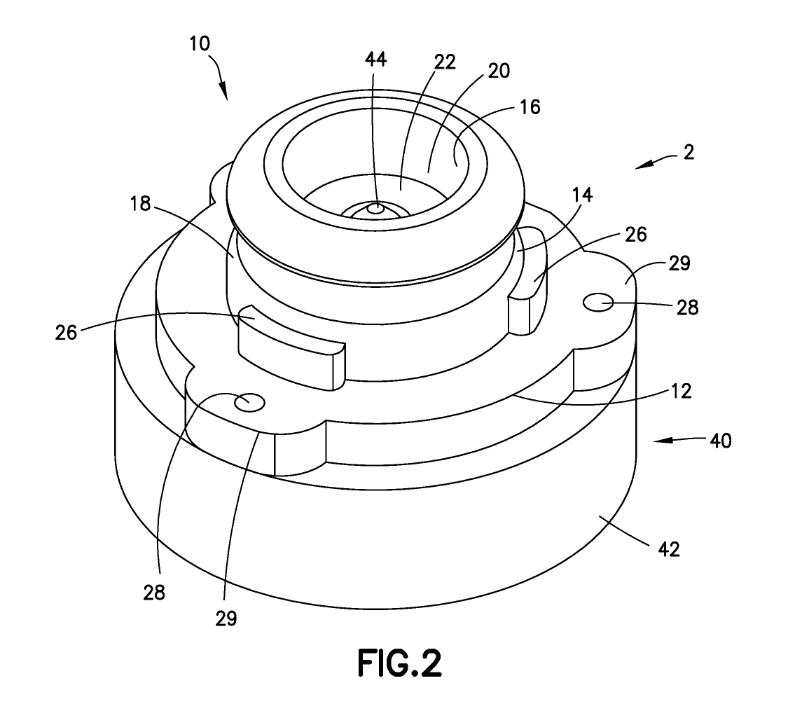

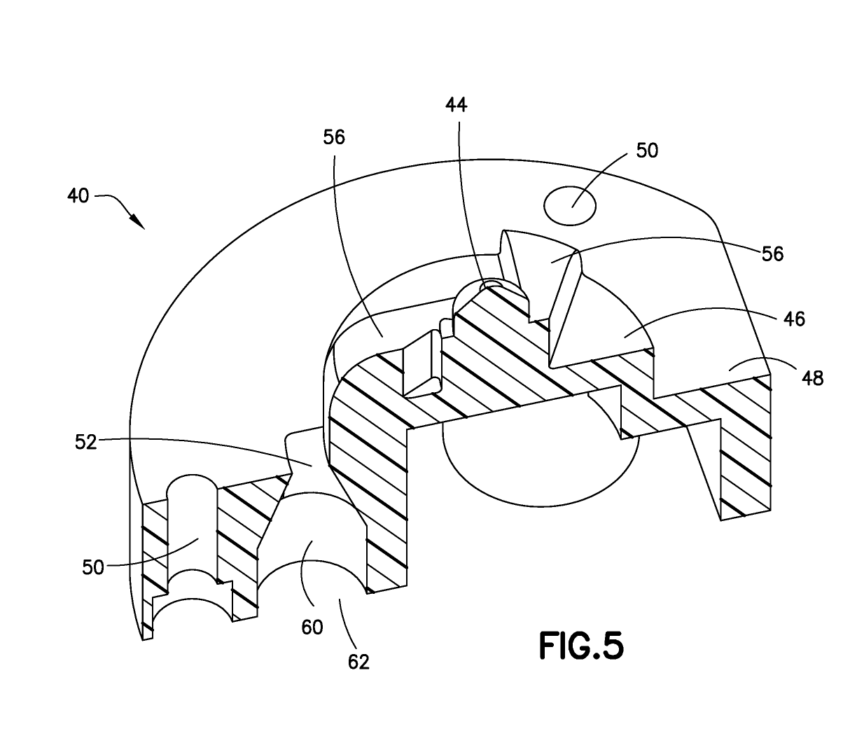

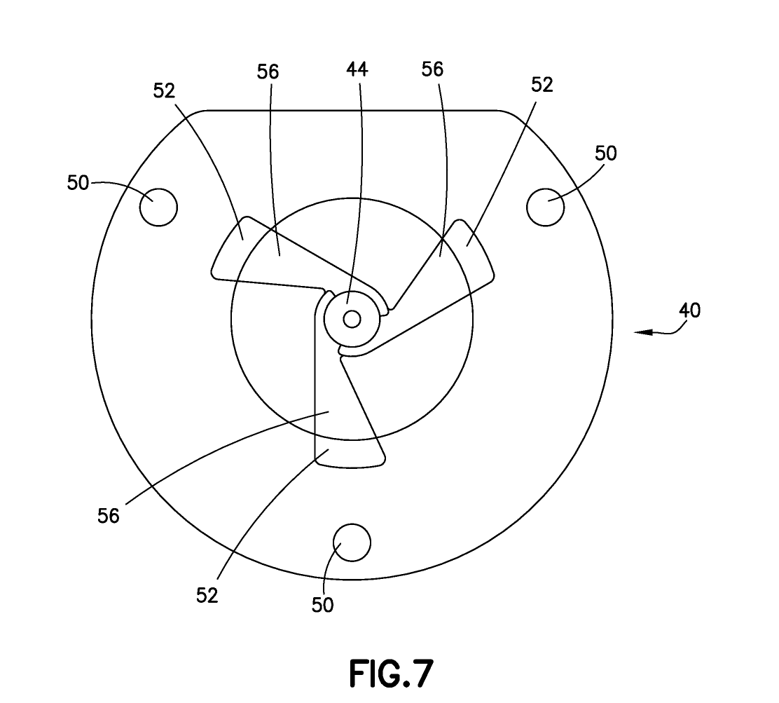

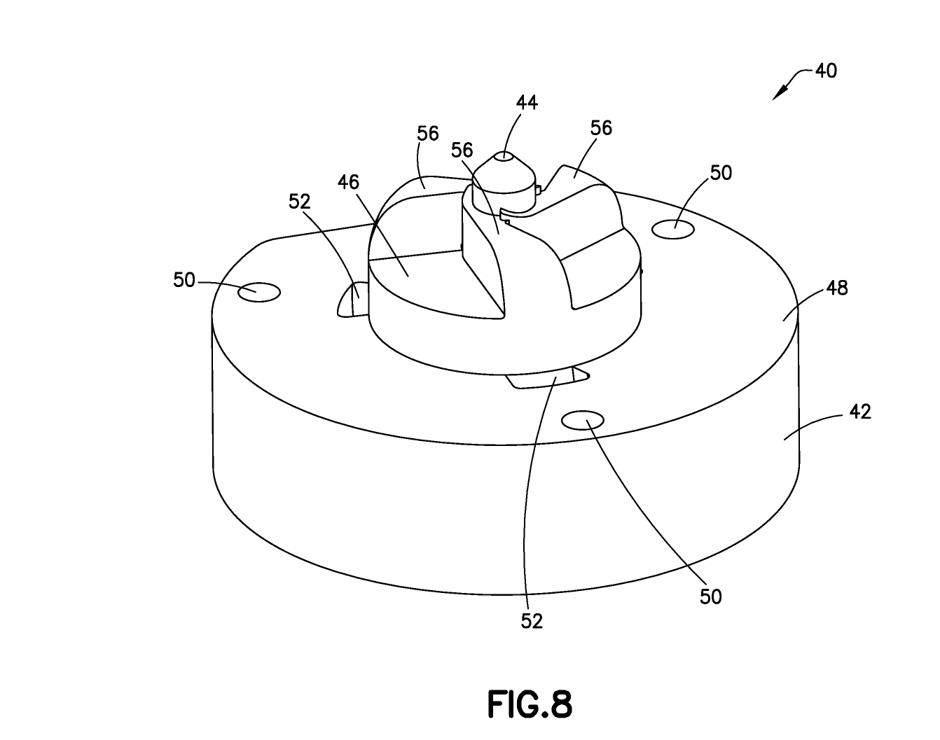

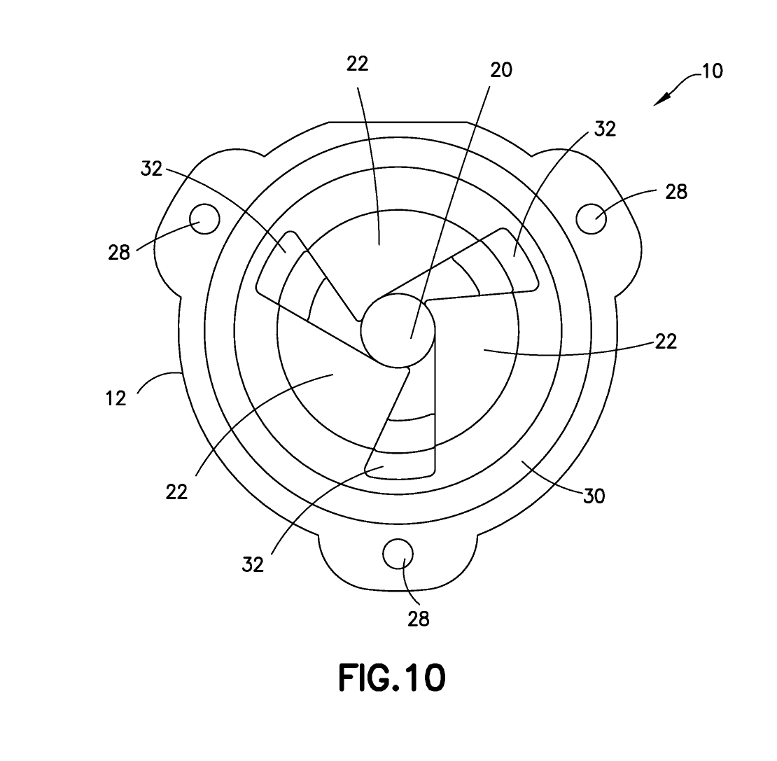

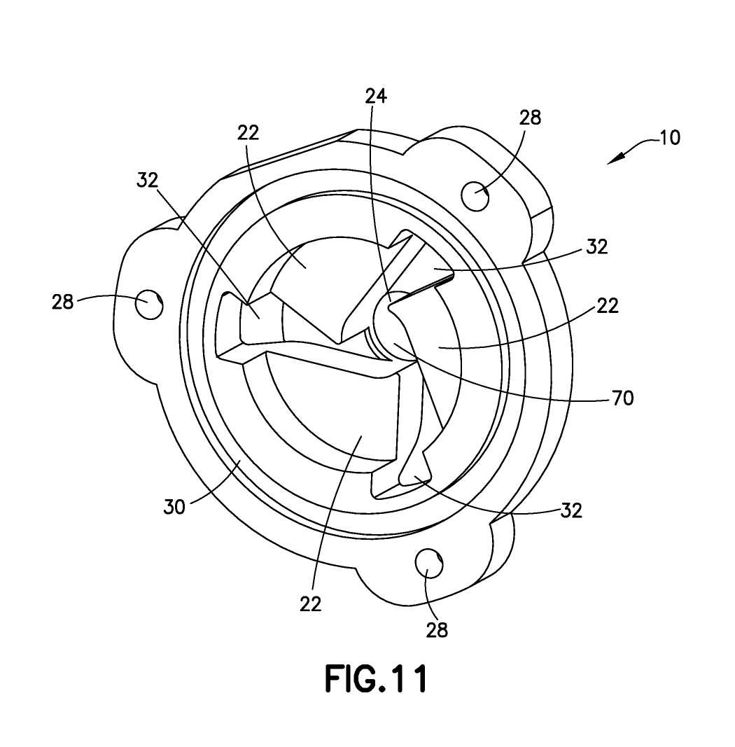

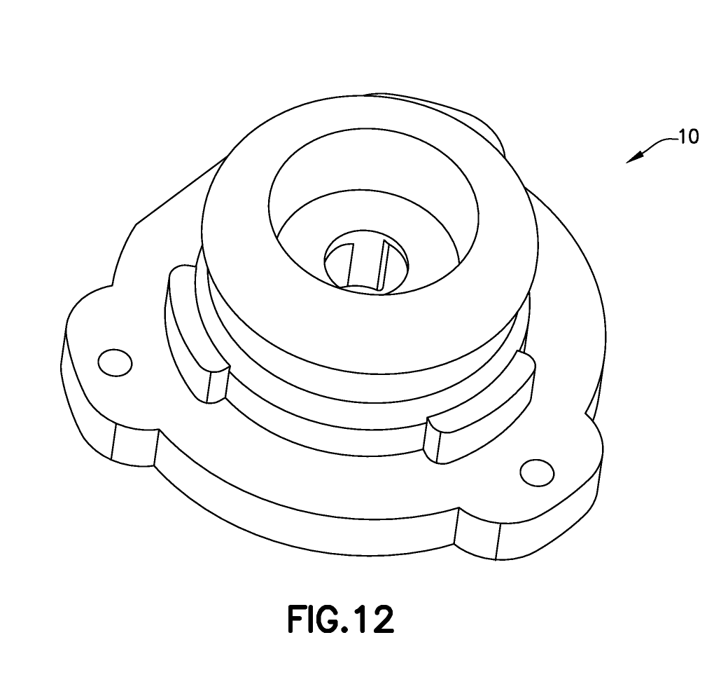

Referring first to FIGS. 1-16, assembly 2 includes an outer shell 10 and nozzle portion 40 that may be fitted together to form or define a swirl chamber 70 therebetween. As shown in FIG. 1, the outer shell 10 is comprised of a base 12, an upper portion 14 having an inner surface 16 and an outer surface 18, and defining therein a generally cylindrical outlet portion 20 defining a bottom portion 22. The bottom portion 22 has a central aperture 24 defining an outlet to the swirl chamber 70. Outer portion 10 further comprises protrusions 26 defining on an interior side thereof channels 54 (not shown in FIGS. 1-2). Orienting holes 28, located in flanges 29 extending radially outwardly in base 12 from protrusions 26, may be used to align the outer shell 10 over and onto nozzle portion 40. Nozzle portion 40 comprises base portion 42 and center shaft 44, which extends through central aperture 24. Nozzle portion 40 includes one or more holes 50. When orienting holes 28 and holes 50 are aligned, the nozzle portion 40 and the shell 10 can be affixed together by fasteners (not shown) extending though orienting holes 28 and holes 50. In such manner, the nozzle portion 40 and the outer shell 10 are maintained fixed in axial and rotational relation to each other, so as to maintain the internal flow structure of the assembly 2. However, the parts may be affixed by any other suitable manner, e.g., adhesive, welding. The use of fasteners extending through the orienting holes 28 and the holes 50 helps ensure the parts are properly aligned when affixed.

Cylindrical outlet portion 20 serves as an outlet from swirl chamber 70. Product that passes through swirl chamber 70 is dispensed through cylindrical outlet 20. In some embodiments, an outlet conduit or tube (not shown) is sealingly attached to cylindrical outlet portion 20 and delivers substance from the swirl chamber 70 to a container for the product or a filling device for filling the product into separate containers. In the illustrated embodiment, there is no valve controlling the flow of fluid through cylindrical opening 20. Rather, a connector, e.g., a sterile connector, may be connected to an outlet end of the outlet tube, and flow through the outlet tube and thus out of the swirl chamber may be controlled by a valve within the connector. The connector at the end of the outlet tube may take any form known or becomes later known to those of skill in the art. Examples of such connectors are disclosed in the following patents or patent applications, whose disclosures are hereby incorporated by reference: U.S. Pat. No. 8,671,964, issued Mar. 18, 2014, titled “Aseptic Connector with Deflectable Ring of Concern and Method;” U.S. patent application Ser. No. 13/874,839, filed May 1, 2013, titled “Device for Connecting or Filling and Method;” U.S. patent application Ser. No. 13/864,919, filed Apr. 17, 2013, titled “Self Closing Connector;” and U.S. patent application Ser. No. 14/536,566, filed Nov. 7, 2014, titled “Device for Connecting or Filling and Method;” and the U.S. patent application filed on even date herewith having docket no. 100811.00059 and entitled “Single Use Connectors,” which claims priority to similarly-titled U.S. Provisional Patent Application No. 62/280,693, filed Jan. 19, 2016. In embodiments where the outlet conduit on one end is sealed to the cylindrical outlet portion 20 and the other end contains a sterile connector, the assembly 2 is maintained sealed from the ambient atmosphere downstream of the cylindrical outlet portion 20, so as to prevent exposure of formulated product exiting the cylindrical outlet portion 20 from ambient atmosphere and air and/or contaminants therein, and/or escape or loss of the product to the ambient atmosphere.

Outer shell 10 and nozzle portion 40 may be made of disposable materials, such as plastics. In some embodiments, the outer shell 10 is made of polyethylene, polyurethane or another plastic material, or a thermoplastic elastomer (TPE) or other elastic material. The outer shell 10 may comprise a HDPE/TPE blend, a PP/TPE blend, a PP/EVOH multilayer or blend, an HDPE/EVOH multi layer or blend, or a HDPE/EVOH multi layer or blend. As may be recognized by those or ordinary skill in the pertinent art based on the teachings herein, these materials are only exemplary, and numerous other materials that are currently known, or that later become known, equally may be used.

The shell 10 and nozzle portion 40 may be formed using any suitable processes that are currently known or later become known. For example, the parts may be molded, or they may be machined from blocks or blanks of material. Alternatively, the shell and nozzle portion may be formed as one integral piece. For example, the entire assembly 2 may be molded as a continuous piece. In yet other embodiments, the shell and the nozzle portion are co-molded with or over-molded to each other.

Advantageously, the use of disposable materials eliminates the need to clean and/or sterilize the components when there is a product changeover, as would be the case for permanent materials, such as stainless steel elements. Such cleaning and sterilizing is costly and time-consuming, and can cause prolonged down time for the system. The disclosed system, by contrast, may be simply disposed of when no longer desired. Furthermore, the components themselves are low-cost, so that overall costs for the system are reduced compared to using permanent components.

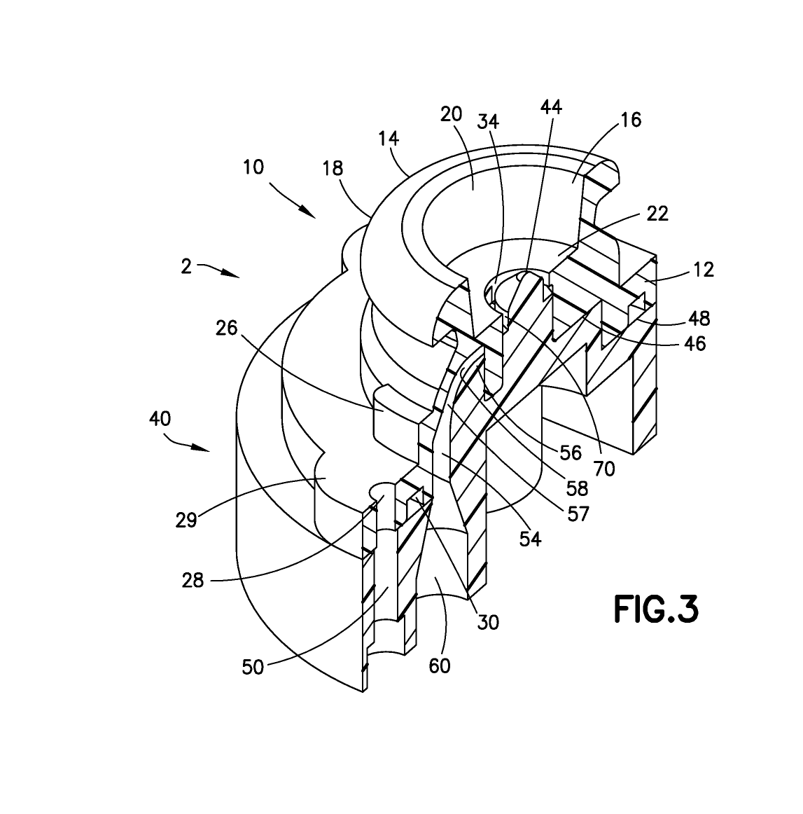

Referring now to FIG. 3, a cross-sectional view of the assembled outer shell 10 and nozzle portion 40 shows internal structures of the assembly 2. Cylindrical bottom portion 22 contacts raised upper surface 46 of nozzle portion 40 to seat the outer shell onto the nozzle portion and help align the central aperture 24 with the center shaft 44, while base 12 contacts surface 48 of nozzle portion 40 to, as discuss above, engage the shell 10 and nozzle portion 40 together to form the internal structures of the assembly 2. When assembled, the central aperture 24 and the center shaft 44 define an annular or substantially annular space 34 therebetween. In some embodiments, the annular space 34 is substantially constant in dimension around the circumference of the center shaft 44. This helps provide consistent flow of product out of the swirl chamber 70 around the circumference, which increases the homogeneity of the mixing within the swirl chamber 70. In other embodiments, the swirl chamber is cylindrical or substantially cylindrical in shape. For example, some such embodiments do not have a center shaft. In such embodiments, mixing still takes place due to the circumferential or substantially circumferential flow inside the swirl chamber.

An annular gap 30 is defined in the underside of base 12 at the point of contact between base 12 and surface 48. In some embodiments, the gap 30 accommodates differential thermal expansion and contraction between the shell 10 and the nozzle portion 40. Hole 50 is shown aligned with hole 28 in the outer portion 10 so that the outer shell 10 and the nozzle portion 40 can be properly aligned and fixed together, as discussed above. Inlet flow channel 60 in the nozzle portion 40 connects to channel 54 defined by space between outer portion 10 and nozzle portion 40, which connects to transition portion 57, which connects to spiral feed channel 58, which connects to and opens into swirl chamber 70. In some embodiments, such as the illustrated embodiment, both inlet flow channel 60 and channel 54 are tapered, which increases the velocity of the flow of the component or substance therethrough, so as to increase or maximize its velocity as it enters the swirl chamber 70.

As can be seen in the figures, each channel 54 and its associated spiral feed channel 58 are communicatively connected by a transition portion 57 extending therebetween. In the illustrated embodiment, the transition portion is gradually curved, so as to minimize or reduce the head loss or K factor of the transition between the channel 54 and the spiral feed portion 56, as the flow changes direction between channel 54 and spiral fee channel 58. A lower head loss results in higher pressure and velocity of the material flow in the swirl chamber.

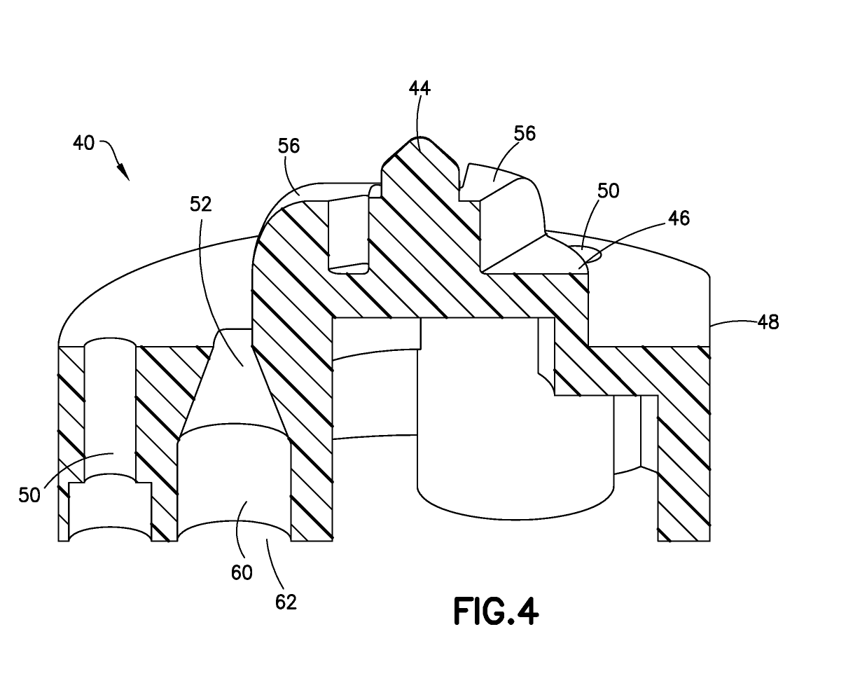

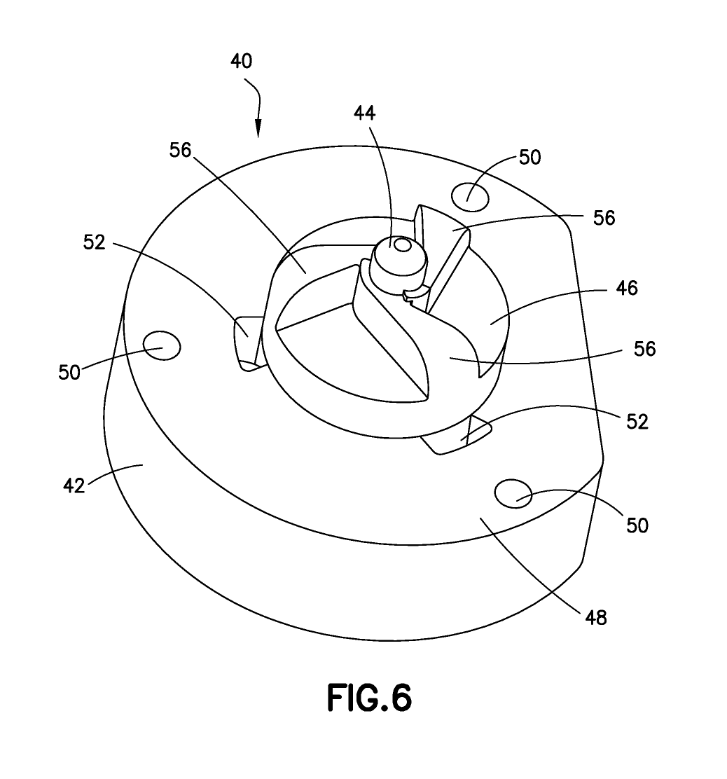

FIGS. 4-8 show various views of nozzle portion 40 to illustrate its structure and configuration. As seen best in FIGS. 6-8, spiral feed portions 56 extend from raised upper surface 46. The spiral feed portions 56 are equally (or substantially equally) spaced about the center shaft 44 in tangential or substantially tangential relationship or intersection thereto. This orientation (1) helps the flow from the spiral feed channels 58 to flow in a circumferential direction around the center shaft 44, i.e., in a swirl direction, and (2) maximizes velocity in the swirl chamber 70, as energy is not lost changing the direction of the flow from the direction in which it enters the swirl chamber 70 to the circumferential direction of flow within the swirl chamber 70. However, in other embodiments the spiral feed portions 56 are not equally spaced circumferentially. The spiral feed portions 56, and the corresponding flow channels 60, channels 54, transition areas 57, and spiral feed channels 58 (not shown in FIGS. 4-8) may be circumferentially located in any location to accomplish the desired mixing of components in the swirl chamber 70. While the spiral feed portions 56 are oriented so that flow within the swirl chamber is primarily in a clockwise direction around the center shaft 44 (as viewed from above), the spiral feed portions 56 may be oriented in the opposite direction so that flow is primarily in a counterclockwise direction. In addition, in some embodiments, such as the illustrated embodiment, the spiral feed portions 56 are tapered, to increase the velocity of the substance entering the swirl chamber 70.

Inlet flow channels 60 dispense material through inlet flow holes 52 in surface 48. When the nozzle portion 40 and the outer shell 10 are aligned and assembled as discussed above, the inlet flow hole 52 of each flow channel 60 lies directly below, and corresponds to, a channel 54, so that material flows through flow channel 50, through inlet flow hole 52, into channel 54, through transition portion 57, and to a spiral feed portion 58. In the illustrated embodiment, nozzle portion 40 has three inlet flow holes 52 and three spiral tapered portions 56. However, as can be understood by those of skill in the art, nozzle portion 40 may contain as few as two inlet holes 52, or as many inlet flow holes 52 as desired, for the mixing of a desired number and proportion of ingredients, as would be understood by those of ordinary skill in the art. Likewise, although there are three spiral feed portions 56, this is merely exemplary, and the nozzle portion 40 can contain as few as two spiral tapered portions 56, or as many spiral tapered portions as desired.

In the illustrated embodiment, each of the three flow paths have the same dimensions and configurations, e.g., length, diameter, etc. However, this is merely exemplary, and each flow path may have a different configuration and dimension in order to achieve the desired mixing and proportions of components, as should be understood by those of ordinary skill in the art. Such differentiation may be desired when, for example, the different ingredients are being mixed in different volumes, weights, or concentrations, or require different flow parameters, e.g., pressure, velocity, etc.

Each inlet flow channel 60 is connected to an ingredient source (not shown). A pump, such as a peristaltic pump (not shown), pumps ingredients from the ingredient source to the inlet channel 60. The speed of the peristaltic pump can be varied according to the desired speed of flowing fluid through the swirl chamber 70. The use of a peristaltic pump eliminates any contact of the pump with the ingredient, and thus, unlike an in-line pump, the pump need not be washed and cleaned for maintenance or product changeover, and reduces possible exposure of the ingredient to outside contaminants.

In order to mix ingredients, at least two of the inlet flow channels 60 are connected to sources of different ingredients. In some embodiments, each inlet flow channel 60 is connected to a different ingredient. In other embodiments, at least two inlet flow channels 60 are connected to the same ingredient, so as to achieve the desired proportion of ingredients in the formulated product. The at least two inlet flow channels 60 may be connected to different sources containing the same ingredient, or the same source, e.g., the same container.

Each of the inlet flow channels 60 may be connected its respective ingredient in any suitable manner, which should be understood to those of skill in the art. For example, a tube may be connected to the inlet flow channel 60 to convey the ingredient from the ingredient source to the inlet flow channel 60.

In embodiments where the ingredient is sterile, e.g., pre-sterilized in a manner best suited for the ingredient, the inlet flow channel 60 may be connected to the ingredient source in a sterile manner that excludes the ambient atmosphere from contacting the ingredient as it flows from the ingredient source to the inlet flow channel 60. For example, the inlet tube carrying a component to the assembly (not shown) may be sealingly (e.g., hermetic seal) connected to the inlet flow channel 60. The other end of the tube may contain a sterile connector so that it may be aseptically connected to the ingredient source. Examples of sterile connectors include, but are not limited to, sterile connectors as disclosed in the patents and patent applications listed and incorporated by reference above.

It should be noted that if all of the inlet flow channels 60 are closed from the ambient atmosphere, e.g., by a sterile connector portion, and the outlet from the swirl chamber 70 is sealed from the ambient atmosphere, e.g., by a sterile connector portion, as described above, then, when the device is assembled, all of the surfaces of the assembly 2 in or over which substance flows are sealed from the ambient atmosphere. Accordingly, the hermetically sealed assembly 2 can be sterilized, by any known mechanism, e.g. autoclave, irradiation, etc., and those flow surfaces will be and remain sterile during use of the assembly 2. Upon sterile connection of the inlet flow channels 60 to ingredients, as described above, and sterile connection or the outlet of the swirl chamber 70 to a destination of the formulated product, the sterile ingredient(s) and resulting formulation can be maintained in sterile condition at every point from the ingredient source to the product destination.

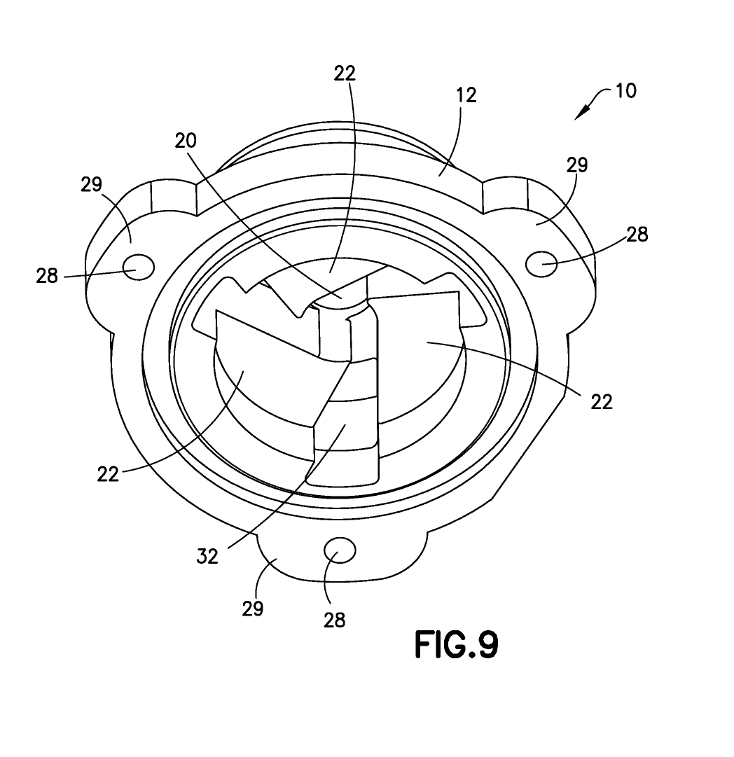

FIGS. 9-12 further illustrate the outer shell 10 that forms, with the nozzle portion 40, the channels 54, the swirl chamber 70, and the flow path(s) therebetween. As shown in FIGS. 9-11, outer shell 10 defines tapered recesses 32 within cylindrical bottom portion 22. The tapered recesses 32, when the nozzle portion 40 and outer shell 10 are aligned and connected as described above, define between the recesses 32 and the spiral feed portions 56 the transition portions 58 and the spiral feed channels 54. The cylindrical portion 22 sealingly engages the nozzle portion 40, leaving only cylindrical opening 24 to form an outlet for the swirl chamber 70. Accordingly, any flow exiting inlet flow holes 52 may flow only into and through the channel 54, transition portion 57, spiral feed channel 58, and swirl chamber 70, and out of the assembly 2 through opening 24.

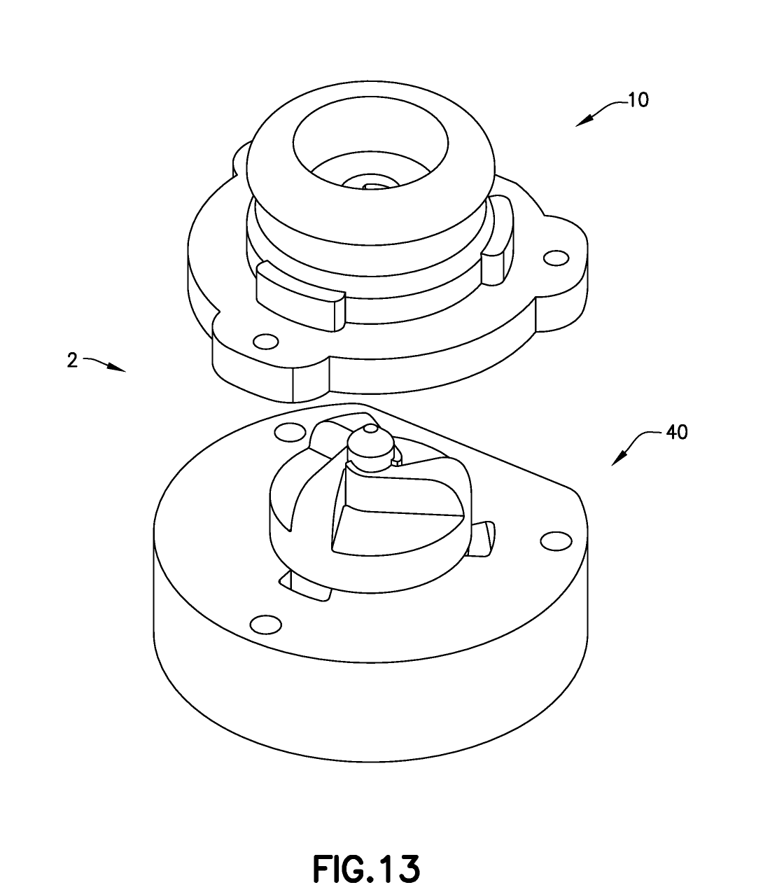

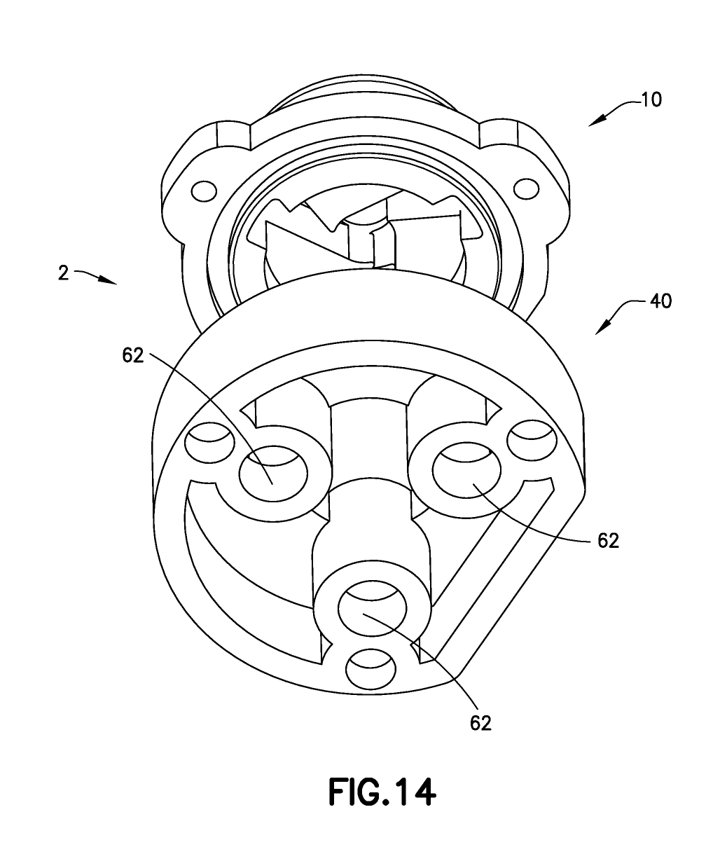

FIGS. 13-14 further illustrate the alignment between outer shell 10 and nozzle portion 40 when connected (e.g., by rotationally aligning the orienting holes 28 and holes 50 as illustrated and the structure of nozzle portion 40. As can be seen in FIG. 14, each of the inlet flow channels 60 comprises an inlet port 62 at its bottom. This inlet port 62 may be connected, e.g., aseptically connected, to the ingredient sources, as described above.

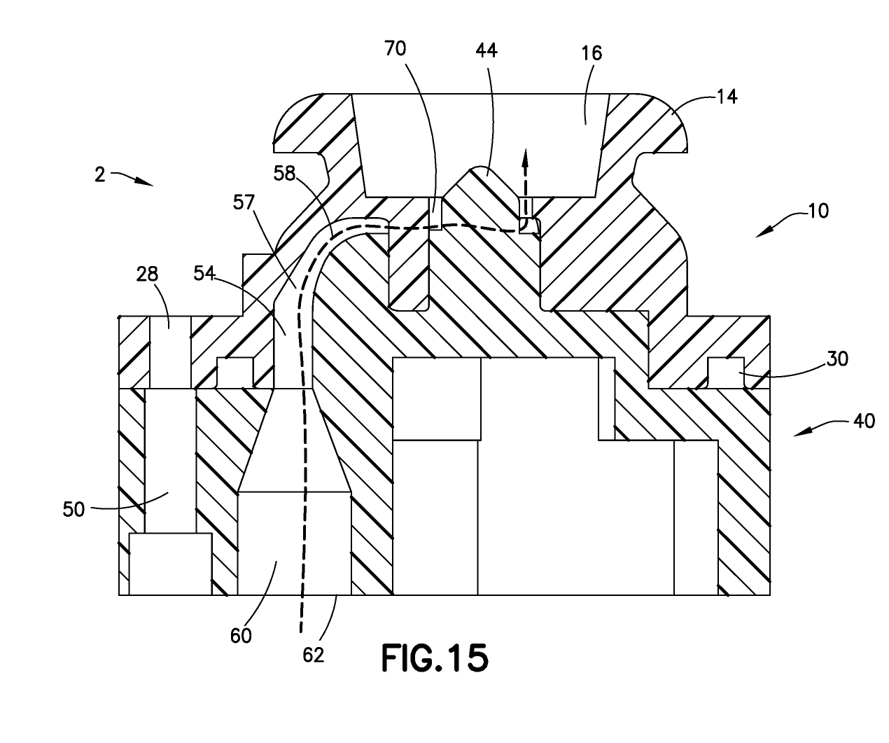

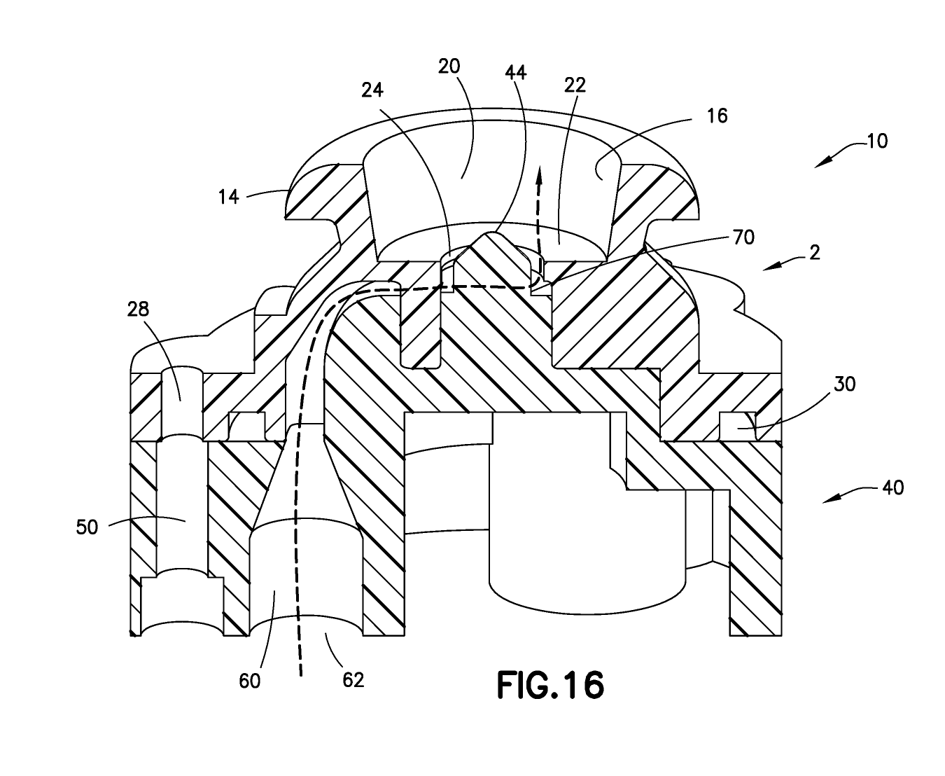

FIGS. 15 and 16 illustrate the flow of material through the assembly 2 when the outer shell 10 and the nozzle portion 40 are assembled. An ingredient enters through inlet port 62 into channel 60, through channel 54, to spiral feed channel 58 via the transition 57, and into the swirl chamber 70, as schematically indicated in by the broken line arrow. As can be seen, the ingredient enters the swirl chamber 70, where it mixes with other ingredients entering the swirl chamber 70 through their respective incoming spiral feed channels 58. The mixed formulation then exits the swirl chamber 70 through the annular space 34 and into the outlet portion 20, which, as discussed above, can be connected to a destination source of the formulated product.

The flow mechanics of the swirl chamber 70 facilitates the mixing process as follows. Each spiral feed channel 58 directs the ingredient into the swirl chamber 70 at a non-radial, e.g., tangential, direction, so as to cause the ingredient to flow in the swirl chamber around center shaft 44. The initially separate ingredient flows collide with each other, causing the ingredients to mix and distribute to form the mixed product. As additional material flows into the swirl chamber 70, the mixing ingredients flow in an upward, spiraling direction around the center shaft 44, continuing to mix until sufficiently homogenized, so that an adequately homogenized formulated product exists the swirl chamber 70 through the annular space 34. In the illustrated embodiment, as discussed above, the product travels along a clockwise-curving path. However, in other embodiments, the assembly is constructed, such as discussed above, so that the materials enter the chamber in the opposite direction so as to travel in a counter-clockwise path, as should be understood by those of ordinary skill in the art.

One factor that affects mixing efficiency and completeness is the velocity of the material in the swirl chamber 70. Higher velocity, i.e., faster movement of the material, results increased mixing and decreased mixing time, resulting in increased homogeneity of the exiting formulation. Several mechanisms may be used to maximize the velocity and mixing in the swirl chamber. As one example, tapering of or decreasing the flow area of the flow path as the material approaches the swirl chamber increases the velocity of the material. On the other hand, this tapering or area decrease introduces a head or pressure loss (energy losses) in the material flow. The tapering of the flow path may be engineered to minimize head losses in the material so that the overall result of the competing flow principles, e.g., increase of velocity due to tapering and head loss from tapering, maximizes the resulting energy and thus velocity of the material to effect mixing.

In addition, the flow paths may be designed to reduce other head losses, e.g., as may be caused by, for example, interaction of moving fluid and stationary walls of a device, specific geometric parameters of the flow conduit, changes in geometry of a conduit, sharpness of turning angles in the fluid path, and other changes in the fluid flow pattern. To this end, the flow path may be designed so as to control or minimize these losses. Reduction of head loss is efficacious to improve speedy mixing of components entering the swirl chamber from different channels.

In the depicted embodiment, as can be seen in the Figures, the transition 57 and corresponding portion of the recess 32 define a gradual curved flow path from the channel 54 to the spiral feed channel 58, as opposed to a sharp transition that would impart a higher head loss. The overall head loss is reduced due to two features: the relatively short length of the narrower end of inlet channels 60, and by the gradual and smoothly curved transition 57 between the channel 54 to the spiral feed channel 58, as defined by the spiral feed portion 56 and the corresponding portion of the recess 32. Material that is channeled upwards from channels 60 through channels 54 to spiral feed channels 58 thus travels along a gradual path and suffers only relatively minor head losses in comparison to a sharp transition or turn that would contribute higher head losses.

Another factor that affects mixing is residence time within the swirl chamber. The longer the materials reside in the swirl chamber, the more mixing and/or homogenization that will take place. For a given set of flow parameters, e.g., flow velocity, flow mass, flow volume, etc., residence time can be controlled by the length of the swirl chamber. Referring to the FIGS. 1-16, the length of the swirl chamber 70 is the distance (vertically in FIG. 15, for example) between the bottom of the swirl chamber adjacent the spiral feed channels 58 and the outlet of the swirl chamber 70 adjacent the generally cylindrical outlet portion 20. As discussed above, the material in the swirl chamber 70 generally follows an upward spiraling path to the outlet of the swirl chamber. The residence time is dictated by the length of the path the material follows. The length of the path is determined, in part, by the length of the swirl chamber. Accordingly, the length of the flow path and thus residence time can be controlled by the provided length of the swirl chamber.

In the depicted embodiment, the cylindrical aperture 24 defining the outlet of swirl chamber 70 is substantially symmetrical around center shaft 44. This configuration is advantageous for mixing. Asymmetries in the annular space 34 between the outer portion 10 and nozzle portion 40 can cause flow variance within the swirl chamber 70 and/or variations in exit flow around the circumference of the outlet, which can contribute to uneven or inefficiency in mixing.

In some embodiments, it may be desirable for the component materials to mix or initially contact each other in a particular order. It may be desirable, for example, for two components to begin mixing prior to a third substance being added into the mixing process. This order may be set by connecting the inlet flow channels 60 to the substance sources in the desired order of contact. For example, in the embodiment illustrated in FIGS. 1-16, as the flow in the swirl chamber is clockwise (as viewed from above), the substance sources should be connected in the clockwise order of the desired contact. As a more specific example, if it is desired that a first substance contact a second substance before contacting a third substance, the source of the second substance should be connected to the inlet flow channel 60 that is adjacent to the inlet flow channel 60 to which the first source of substance is connected in the clockwise direction.

It should be appreciated by those of ordinary skill in the art that the various ingredients or components that may be mixed in the swirl chamber 70 may be any materials that may be flowed from a source to the swirl chamber. This can include, but is not limited to liquids, creams, flowable solids, e.g., powders, semi-solids, semi-liquids, and the like. The invention is not limited to any particular materials or ingredients.

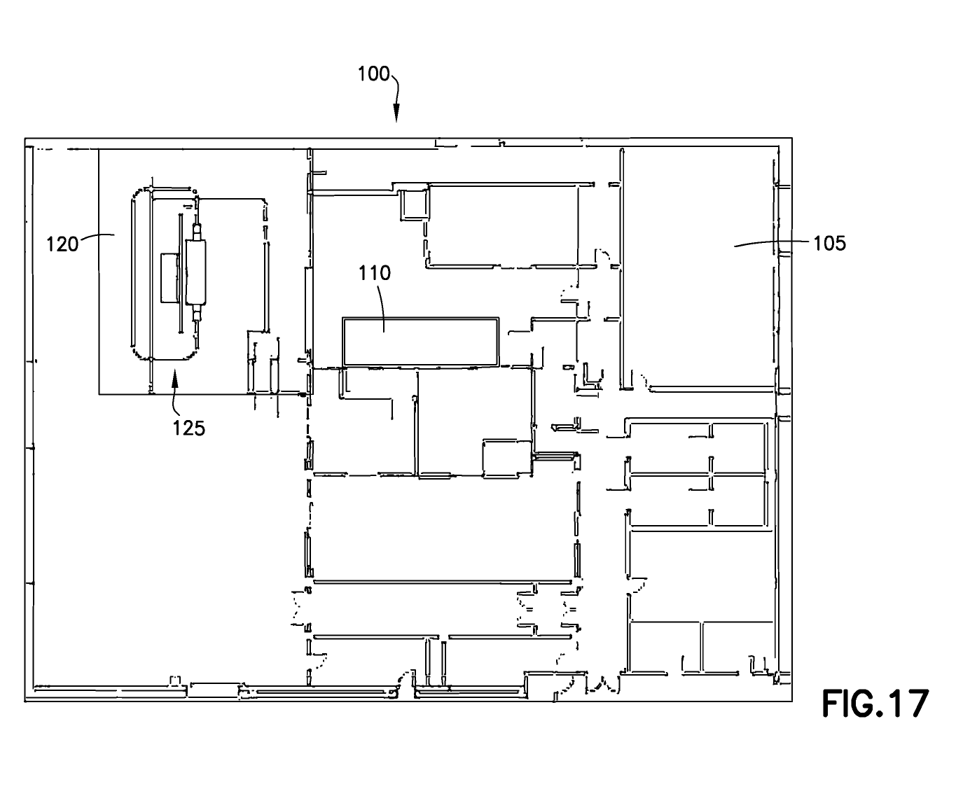

FIG. 17 schematically depicts an environment 100 where the current invention or embodiments thereof may be used. The environment includes a substance source area 105, a blending area 110, which can include one or more assemblies as described above, e.g., of nozzle portions and outer shells, and filling area 120, which can include one or more filling machines 125 for filling product container, such as, described in, for example, U.S. Pat. No. 8,966,866, issued Mar. 3, 2015; entitled “Modular Filling Apparatus and Method,” which is incorporated by reference as part of this disclosure. The entirety of the substance flow system can be permanently closed and sealed from the environment as described herein, except between the substance source area 105 and the blending area 110, and between the blending area 110 and the filling area 120, where connections are made, respectively, between the substance sources (not shown in FIG. 17) in the substance source area 105 and blending assemblies (not shown in FIG. 17), and between the blending assemblies and the filling machine 125. For the former, for example, connections may be made between the substance sources and the inlet flow channels 60 to the swirl chamber 70. For the latter, for example, connections may be made between the cylindrical outlet portion 20 and the filling machine 125.

Thus, substances may flow (e.g., be pumped) through fluid conduits or other flow systems from the substance source areas 105 to the assemblies where they flow into the swirl chamber and are mixed. Upon exiting the swirl chamber, fluid conduits carry formulated product from the blending area 110 to the filling area 120. In the filling area 120, further connections may be made, for example, between those conduits and a filling machine. In addition, in the filling area 120, a fluid connection may be made between the filling machine and a closed device (e.g., a vial) to be filled with the product, for example, by a filling member (e.g., needle, cannula, or probe). Other than at these connections, though, the system is entirely closed to the atmosphere.

However, these connections can be sterile connections by using sterile connectors, such as those described above. Accordingly, the entire flow path from the component sources in the substance storage area 105 to the filling machine 125 and even the product container can be made sterile and closed to ambient atmosphere, while allowing disconnection and reconnection of the connections. For example, the substance sources may be disconnected from the assemblies in the blending area 105 to change sources, e.g., the source container is empty and a new source container is connected. It should be appreciated by those or ordinary skill in the art, then, that the different systems in the environment 100 may be located anywhere between which the desired connections may be made, e.g., without a requirement that the substance source area 105, the blending area 110, and the filling area 120 be continuous or adjacent to each other. This provides flexibility to locate the different areas where it is most beneficial to do so. For example, if desired, the substance source area 105 could be located near a loading dock so that the substances do not need to be transported far after receipt, without the blending area 110 and the filling area 120 also being located near the loading dock.

It should also be appreciated that due to the aseptic capabilities of the invention and/or embodiments thereof, no or limited environmental controls may be required. This may be especially so outside of where connections are made, e.g., outside of the blending area 110 and the filling area 120, such that no environmental controls may be required. In some embodiments, the areas where sterile connections are made may be non-controlled environments. In the blending area 110 and the filling area 120, for example, due to the use of sterile connections in these areas, these areas need only be a Controlled non-Classified environment, e.g., HEPA filtered, with laminar airflow, and positive pressure flow, to reduce the chance of contamination to near zero. The filling area 120 and blending area 110 may also have any of the characteristics disclosed in U.S. Pat. No. 8,966,866, which is incorporated by reference above.

As may be recognized by those of ordinary skill in the pertinent art based on the teachings herein, numerous changes, modifications and improvements may be made to the above-described and other embodiments of the present invention without departing from the scope of the invention as defined in the appended claims. It should be understood that the features disclosed herein can be used in any combination or configuration, and is not limited to the particular combinations or configurations expressly specified or illustrated herein. Thus, in some embodiments, one or more of the features disclosed herein may be used without one or more other feature disclosed herein. In some embodiments, each of the features disclosed herein may be used without any one or more of the other features disclosed herein. In some embodiments, one or more of the features disclosed herein may be used in combination with one or more feature that is disclosed (herein) independently of said one or more features. In some embodiments, each of the features disclosed (herein) may be used in combination with any one or more feature that is disclosed herein independently of said one or more features.

In addition, the invention may be used in conjunction with the disclosures of the following U.S. patent applications, filed on even date herewith, each of which is incorporated herein by reference: entitled “Single Use Connectors” (Attorney Docket No. 100811.00059), which claims priority to similarly-titled U.S. Provisional Patent Application No. 62/280,693, filed Jan. 19, 2016; entitled “Devices and Methods for Formulation Processing” (Attorney Docket No. 100811.00060), which claims priority to similarly-titled U.S. Provisional Patent Application No. 62/280,696, filed Jan. 19, 2016; entitled “Pouch with Fitment and Method of Making Same” (Attorney Docket No. 100811.00061), which claims priority to U.S. Provisional Patent Application No. 62/295,139, filed 14 Feb. 2016, U.S. provisional patent application Ser. No. 62/298,214, filed 22 Feb. 2016, and U.S. provisional patent application Ser. No. 62/323,561, filed 15 Apr. 2016, each of which is entitled “Pouch With Over-Molded Fitment And Method Of Making Same,” and U.S. Provisional Patent Application No. 62/280,700, filed 19 Jan. 2016, entitled “Pouch with Heat-Sealed External Fitment.” Accordingly, this detailed description of currently preferred embodiments is to be taken in an illustrative, as opposed to a limiting sense.

What is claimed is:

1. An apparatus for mixing comprising:
a body including a swirl chamber therein, at least two inlet flow paths in fluid communication with the swirl chamber for delivering substance into the swirl chamber, and an outlet aperture in fluid communication with the swirl chamber for substance to pass out of the swirl chamber;
wherein at least one of the at least two inlet flow paths is in fluid communication with a first substance and at least one of the at least two inlet flow paths is in fluid communication with a second substance that is different than the first substance so that the first substance and the second substance entering the swirl chamber are mixed in the swirl chamber, and a resulting mixture exits the swirl chamber through the outlet aperture.

2. The apparatus of claim 1, wherein the body includes
a nozzle portion defining said outlet aperture; and
an outer shell positioned over and engaged with the nozzle portion;
the nozzle portion and the outer shell defining therebetween the swirl chamber and at least part of the at least two inlet flow paths.

3. The apparatus of claim 2, wherein each of the at least two inlet flow paths are defined at least in part by a recess in the outer shell.

4. The apparatus of claim 1, wherein at least a portion of one or more of the at least two inlet flow paths are tapered.

5. The apparatus of claim 1, wherein the at least two inlet flow paths include at least three inlet flow paths and (i) all the inlet flow paths are in fluid communication with a different substance or (ii) at least two of the inlet flow paths are in fluid communication with a same substance.

6. The apparatus of claim 1, wherein the swirl chamber defines a substantially annular or a substantially cylindrical shape.

7. The apparatus of claim 1, wherein the at least two inlet flow paths define an at least substantially tangential intersection with the swirl chamber.

8. The apparatus of claim 1, wherein a shape of at least one of the at least two inlet flow paths defines an increase in a velocity of flow exiting the at least one of the at least two inlet flow paths and entering the swirl chamber in comparison to a velocity of flow entering said at least one of said at least two inlet flow paths and a minimized head or energy loss of flow though said at least one of said at least two inlet flow paths for said increase.

9. The apparatus of claim 1, further comprising, for each of the first substance and the second substance, a pump to pump a respective one of the first substance and the second substance to respective ones of the at least two inlet flow paths.

10. The apparatus of claim 9, wherein the pump does not contact said respective first substance or second substance.

11. The apparatus of claim 10, wherein the pump includes a peristaltic pump.

12. The apparatus of claim 1, further comprising an outlet conduit sealingly engaged with the outlet aperture and, with respect to each of the at least two inlet flow paths, an inlet conduit sealing engaged therewith, wherein an upstream end of each inlet conduit includes a sterile connector portion sealingly engaged therewith, and a downstream end of the outlet conduit includes a sterile connector portion sealingly engaged therewith.

13. The apparatus of claim 12, wherein all surfaces over which substance flows between said upstream end and said downstream end are sterile and hermetically sealed from ambient atmosphere, and wherein said sterile connector portions maintain said surfaces hermetically sealed from ambient atmosphere during disconnection and reconnection thereof.

14. A method comprising:
flowing a first substance through a first inlet flow path and into a swirl chamber;
flowing a second substance that is different from the first substance through a second inlet flow path and into the swirl chamber;
mixing the first substance and the second substance within the swirl chamber; and
dispensing a resultant mixed product out of the swirl chamber.

15. The method of claim 14, further comprising pumping the first substance from a source thereof to the first inlet flow path and pumping the second substance from a source thereof to the second inlet flow path.

16. The method of claim 15, wherein said pumping is performed by at least one pump that does not contact the first substance or the second substance.

17. The method of claim 14, wherein the dispensing step includes dispensing the mixed product to one or more of (i) a filling machine or (ii) a sterile, closed container.

18. The method of claim 14, further comprising one or more of (a) increasing a velocity of flow of the first substance in the first inlet flow path after the first substance enters the first inlet flow path or (b) increasing a velocity of flow of the second substance in the second inlet flow path after the second substance enters the second inlet flow path.

19. The method of claim 18, further comprising minimizing head or energy loss during said increasing.

20. The method of claim 14, further comprising flowing one or more additional substances though one or more additional inlet flow paths and into the swirl chamber, and mixing said one or more additional substances with the first substance and the second substance in the swirl chamber.

21. The method of claim 14, further comprising flowing the first substance through a third inlet flow path and into the swirl chamber.

22. The method of claim 14, further comprising flowing the first substance and the second substance into the swirl chamber at a substantially tangential direction to the swirl chamber.

23. The method of claim 14, further comprising flowing the first substance and the second substance in the swirl chamber in a substantially circumferential direction.

24. The method of claim 14, further comprising flowing the first substance and the second substance in the swirl chamber in an upward spiral direction.

25. The method of claim 14, further comprising aseptically connecting the first inlet flow path to a source of the first substance and aseptically connecting the second inlet flow path to a source of the second substance.

26. The method of claim 25, further comprising sterilizing the first substance with a first sterilizing procedure and sterilizing the second substance with a second sterilizing procedure that is different than the first sterilizing procedure.
